(19) United States
(12) Patent Application Publication
(10) Pub. No.: US 2006/0236467 A1
(43) Pub. Date: Oct. 26, 2006

(54) Functionalized vegetable oil derivatives, latex compositions and textile finishes

(76) Inventors: Shelby F. Thames, Hattiesburg, MS (US); James W. Rawlins, Petal, MS (US); Sharathkumar K. Mendon, Hattiesburg, MS (US); Ericka N. Johnson, Columbus, GA (US); Zhanqing Yu, Hattiesburg, MS (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(21) Appl. No.: 11/387,065

(22) Filed: Mar. 22, 2006

Related U.S. Application Data
(63) Continuation-in-part of application No. 10/800,410, filed on Mar. 12, 2004.

(51) Int. Cl. C11D 3/00

(52) U.S. Cl. 8/115.51

(57) ABSTRACT

An ethylenically unsaturated vegetable oil is modified by the addition of an enophile or dienophile having an acid, ester or anhydride functionality. The modified vegetable oil is then reacted with a functional vinyl monomer to form a vegetable oil derivative. The vegetable oil derivative is useful in forming latexes, coatings and textile finishes.

This application is a continuation-in-part application of Ser. No. 10/800,410 filed Mar. 12, 2004.

### BACKGROUND OF THE INVENTION

The present invention is directed to vegetable oil derivatives. More particularly, the present invention is directed to functionalized vegetable oil derivatives that can be used in latexes, coatings and textile finishes.

One problem encountered by coatings manufacturers is the development of formulations containing low VOC-coalescing aids or plasticizers. For instance, emulsion polymers are currently formulated with coalescing aids or plasticizers in order to form films at and below ambient conditions yet dry to films of sufficient glass transition temperature (T_{g}) to perform adequately at and above room temperature. In general, the ability of emulsion polymers to form or coalesce into film is governed by the minimum film forming temperature (MFT) of the polymer in question. Low MFT polymers are required in order to exhibit coalescence, flow, and surface wetting properties. However, if the polymer remains soft and tacky, the coatings are not usable. Therefore, it is necessary to develop a technology in which coating formulations contain suitable ingredients to provide an initial low MFT, which, upon application, form nontacky, durable, hard, and water resistant surfaces having a T_{g} significantly above their MFT.

Various other coating compositions which cure under ambient conditions are known in the prior art. A few such examples involve curing by a chemical reaction such as epoxide-carboxylic acid reaction, isocyanate-moisture reaction, polyaziridine-carboxylic acid reaction, and activated methylene-unsaturated acrylic reaction.

Recently, a number of new latex or emulsion compositions derived from semi-drying and/or non-drying oils have been developed for use in coatings, adhesives and inks. Such compositions are disclosed in U.S. Pat. Nos. 6,001,913; 6,174,948; and 6,203,720 each of which is incorporated herein by reference in its entirety.

Textile fabrics are often treated with low molecular weight compounds and polymeric resins to prepare fibers for textile processes and consumer satisfaction. Durable coatings are capable of withstanding multiple laundering cycles.

Sizing is applied to fibers to prevent breakage during textile processing. Sizes create low friction surfaces and enhance the abrasion resistance via adequate surface coverage and interfacial adhesion. Starch and polyvinyl alcohol are commonly used sizes for textile processing. Sizing, colorants, waxes, and other non-cellulosic impurities are removed from cotton during the preparation stages of desizing, scouring, and bleaching.

Frequent use of cellulosic textiles leads to the formation of wrinkles that affect their aesthetic appearance. Starch is a commonly employed temporary surface agent that is used to eliminate the wrinkles during ironing. Textile manufacturers have long sought the application of wrinkle-resistant finishes to maintain creases and pleats. “Easy care”, “wrinkle free”, and “wash ‘n’ go” performance characteristics of apparel garments are made possible through the use of durable press resin finishes. Fabric blends afford the synergy of inherently wrinkle resistant synthetic fibers like polyester, nylon, and spandex with the comfortable wear and home laundering benefits of cotton.

Typical durable press formulations are composed of water, a wetting agent, softener, crosslinking agent, and catalyst. The crosslinking agents are designed to react with cellulose hydroxyl groups and are traditionally based on formaldehyde derivatives, such as dimethylol dihydroxy ethylene urea (DMDHEU). Formaldehyde is recognized by the EPA as a carcinogen. Nonformaldehyde release reactants typically contain multiple carbonyl and carboxylic acid groups, e.g., glyoxal and polycarboxylic acids such as 1,2,3,4 tetrabutanecarboxylic acid (BTCA) and citric acid. BTCA performs similar to DMDHEU but is considerably more expensive, while citric acid is useful only with colored fabrics. The hazardous health concerns identified with formaldehyde and the threat of continual formaldehyde release throughout the usage of the durable pressed garment has promoted research towards effective and less expensive alternatives to formaldehyde-based crosslinking agents as is evident from U.S. Pat. Nos. 5,273,549; 5,496,476; 5,496,477; 5,705,475; 5,728,771; 5,965,517; 6,277,152, WO 01/21677, and WO 03/033806.

The search for additional compositions that can be used in latexes and coatings is continuing. Accordingly, it would be an advancement in the art to provide compositions that can be made from renewable resources that are suitable for use in latexes, coatings and textile finishes.

### SUMMARY OF THE INVENTION

The present invention is directed to functionalized vegetable oil derivatives which are useful in latexes, coatings and textile finishes. In the preferred embodiment, an ethylenically unsaturated vegetable oil is modified by the addition of an enophile or dienophile having an acid, ester or anhydride functionality. The modified vegetable oil is then reacted with a functional vinyl monomer to form the vegetable oil derivative. Suitable monomers include hydroxy, amine, thiol, oxirane vinyl monomers. The functionalized vegetable oil derivatives can be formulated into latexes, textile finishes and other coating compositions.

The present invention provides vegetable oil derivatives for treating fabrics and textiles by reacting vegetable oil with maleic anhydride and neutralizing the product with a suitable base. Specifically, we have synthesized maleinized soybean oil (MSO), and soybean acrylate monomer (SAM) by partially acrylating MSO. SAM was neutralized with bases such as sodium hydroxide and ammonium hydroxide, and copolymerized with butyl acrylate and methyl methacrylate via emulsion polymerization. MSO and SAM were neutralized with the same bases to yield neutralized MSO (nMSO) and neutralized SAM (nSAM), respectively. nMSO, nSAM, and nSAM-based latexes were individually evaluated in durable press finishes for cotton fabrics. Each of the three products improved the wrinkle resistance of untreated cotton fabrics.

### DETAILED DESCRIPTION OF THE PREFERRED EMBODIMENTS

The present invention is directed to a series of vegetable oil macromonomers and their use in latexes and coatings. The invention is also directed to the method of producing these macromonomers. This set of monomers is derived by reacting unsaturated vegetable oils with an enophile or dienophile having an acid, ester or anhydride functionality, and then reacting the derivative with a suitable hydroxy, amine, thiol, oxirane, or other functional vinyl monomer.

In a preferred embodiment, an unsaturated vegetable oil, such as soybean oil is reacted with maleic anhydride to form a maleinized vegetable oil as schematically shown in Reaction 1. Preferably, the reaction is performed at a temperature of about 200° C. to about 240° C. More preferably, the reaction is performed at a temperature of about 210° C. to about 220° C.

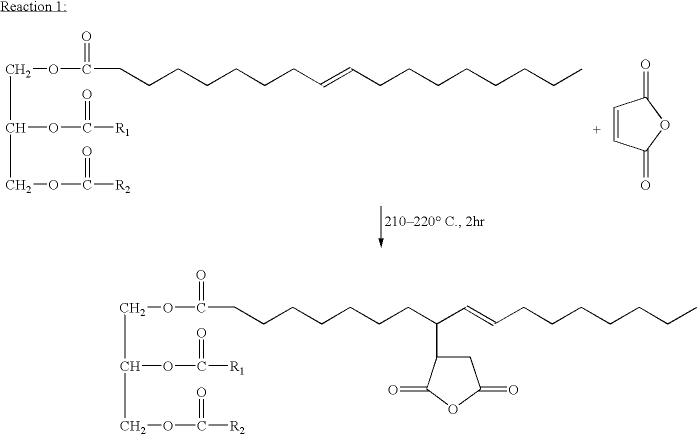

Any unsaturated vegetable oil can be used in the present invention. However, linseed oil, soybean oil and sunflower oil are preferred.

Many different compounds can be used to modify the unsaturated vegetable oil. They include enophiles and dienophiles that contain acid, ester or anhydride functionality. Examples include but are not limited to maleic anhydride, fumaric acid, itaconic anhydride and maleate esters.

The modified vegetable oil is then reacted with a suitable functional vinyl monomer to form the macromonomers of the present invention. A series of exemplary reactions are illustrated in Reactions 2a-2e. In Reaction 2a, the maleinized vegetable oil is reacted with hydroxyethyl acrylate (HEA) or hydroxyethyl methacrylate (HEMA). In Reaction 2b, the maleinized vegetable oil is reacted with 2-(tert-butylamino)ethyl methacrylate (BAEMA). In Reaction 2c, the maleinized vegetable oil is reacted with glycidyl acrylate (GA) or glycidyl methacrylate (GMA). In Reaction 2d, the malenized vegetable oil is reacted with allyl amine. Finally, in Reaction 2e, the maleinized vegetable oil is reacted with a vinyl ether such as hydroxybutyl vinyl ether where R is —(CH₂)₄—.

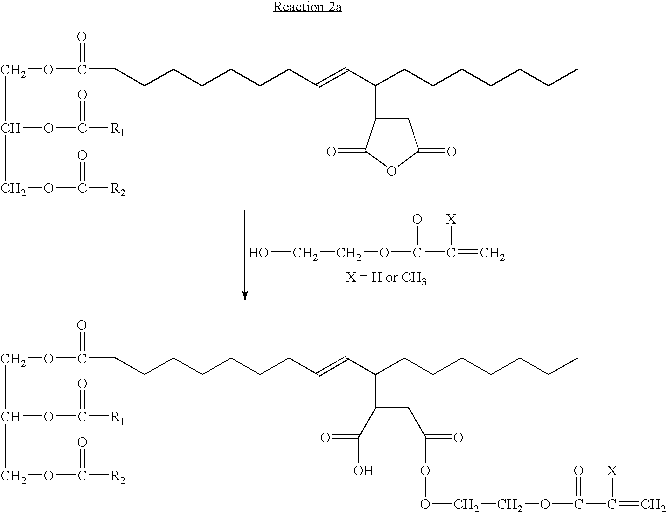

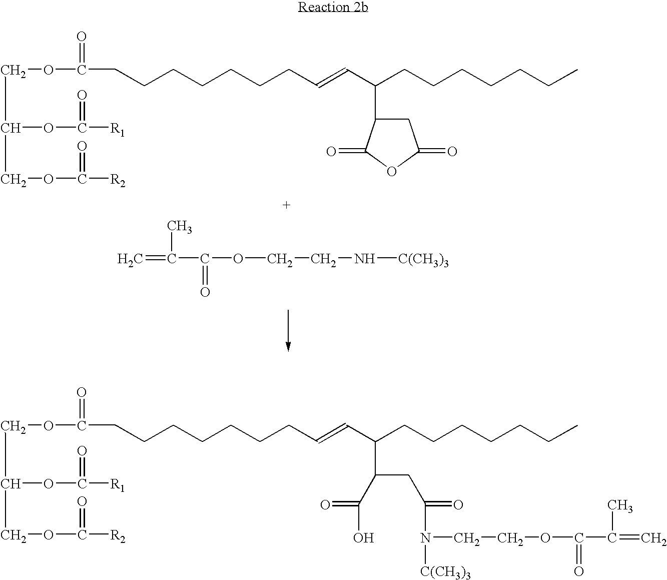

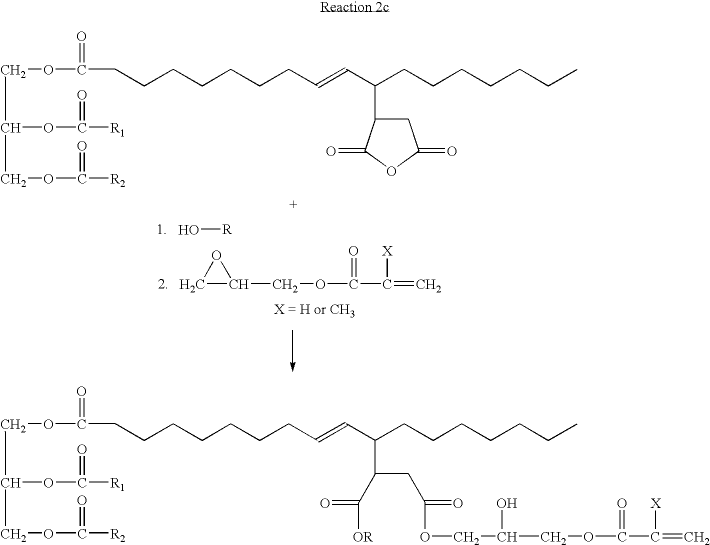

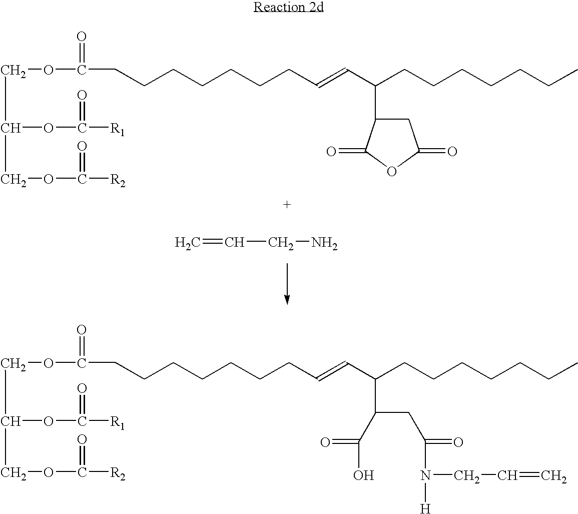

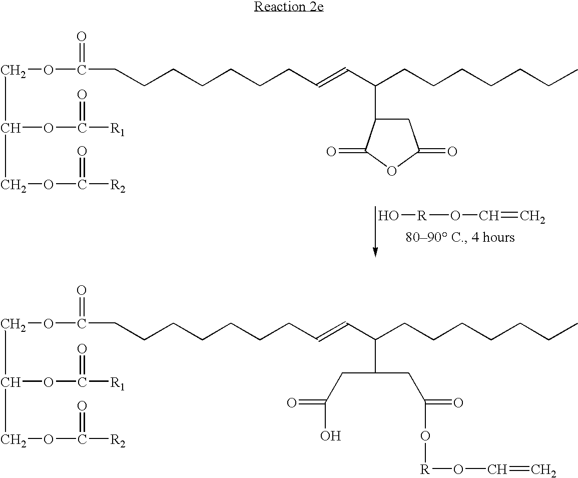

Examples of additional functionalized vinyl monomers that can be used in the present invention include, but are not limited to, hydroxypropyl acrylate, hydroxypropyl methacrylate, hydroxybutyl acrylate, hydroxybutyl methacrylate, allyl alcohol, 3-butenol, acrylamide and methacrylamide.

The macromonomers of the present invention can be used to make latexes and coatings compositions. In the preferred embodiment, the latexes are formed in a staged polymerization process as disclosed in published U.S. Application 2003/0045609, the teachings of which are hereby incorporated by reference. However, non-staged latex polymerization processes can also be used.

The modified vegetable oils of the present invention can then be copolymerized with conventional functionalized monomers in emulsion polymerization processes to produce vinyl polymers.

The modified vegetable oils of the present invention can be neutralized with a suitable base so as to form the basis of textile finishes. Specifically, we have synthesized maleinized soybean oil (MSO), and soybean acrylate monomer (SAM) by partially acrylating MSO. SAM was neutralized with bases such as sodium hydroxide and ammonium hydroxide, and copolymerized with butyl acrylate and methyl methacrylate via emulsion polymerization. MSO and SAM were neutralized with the same bases to yield neutralized MSO (nMSO) and neutralized SAM (nSAM), respectively. nMSO, nSAM, and nSAM-based latexes were individually evaluated in durable press finishes for cotton fabrics. Each of the three products improved the wrinkle resistance of untreated cotton fabrics.

Dimethylol dihydroxy ethylene urea (DMDHEU) and their methyl and glyoxal derivatives are commercially used to impart wrinkle resistance to cotton fabrics and blends. DMDHEU-treated fabrics exhibit lower tensile and tear strength values relative to untreated cotton. However, cotton fabrics treated with the soy oil derivatives displayed higher tensile and tear strengths than DMDHEU-treated fabrics. Moreover, soybean oil-based derivatives impart softness similar to commercial petroleum-based softeners employed in treating cotton fabrics that are derived from polyethylene and silicones. U.S. Pat. Nos. 3,926,550 and 2,706,713 respectively disclose the use of vegetable oils in durable press finishing and sizing.

The invention is further understood by reference to the following examples which describe the formation of various macromonomers as well as the formulation of latexes and coatings.

### EXAMPLE 1

Soybean oil (51.03 kg) was heated in a reactor to 100° C., and nitrogen gas was passed through the reaction mixture to remove the oxygen in the system. Maleic anhydride (14.17 kg) and xylene (2.93 mL) were added and the temperature was slowly raised to 205-210° C. and held for 2.5 hours. The maleic anhydride concentration was followed via gas chromatography (GC). Heating was stopped when the maleic anhydride concentration reached 1-2%, and the reaction mixture was cooled to 90° C.

Phenothiazine (86 g) was mixed with hydroxyethyl acrylate (13.30 kg) and added to the reactor. Next, 86 g of phosphoric acid (85% solution in water) was added to the reaction mixture. The temperature was raised to 110-115° C. and heating was continued for 2.5 hours. Heating was stopped when the hydroxyethyl acrylate concentration dropped below 4% (determined by GC). The reaction mixture was cooled to 60-70° C. and the reaction product, monomer ‘A’ was discharged.

### EXAMPLE 2

Maleic anhydride (48 g) was mixed with linseed oil (152 g) and nitrogen gas was passed through the reaction mixture to remove the oxygen in the system. The reaction mixture was heated to 150° C. over 30 minutes and then heated to 200° C. where it was held for 2.5 hours. The reaction mixture was cooled to 50° C., and hydroxyethyl acrylate (58 g), phenothiazine (0.25 g), and phosphoric acid, 85% solution in water (0.25 g) were added to the reaction mixture. The reaction was continued for 3-5 hours at 80° C. till all the hydroxyethyl acrylate had reacted to yield monomer ‘B’.

### EXAMPLE 3

Maleic anhydride (72 g) was mixed with soybean oil (221 g) and nitrogen gas was passed through the reaction mixture to remove the oxygen in the system. The reaction mixture was heated to 150° C. over 30 minutes and then heated to 200° C. where it was held for 2.5 hours. The reaction mixture was cooled to 50° C., and hydroxyethyl methacrylate (105 g), phenothiazine (0.25 g), and 1-methyl imidazole (0.30 g) were added to the reaction mixture. The reaction was continued for 3-5 hours at 110° C. till all the hydroxyethyl acrylate had reacted to yield monomer ‘C’.

### EXAMPLE 4

Maleic anhydride (46 g) was mixed with linseed oil (215 g) and nitrogen gas was passed through the reaction mixture to remove the oxygen in the system. The reaction mixture was heated to 150° C. over 30 minutes and then heated to 200° C. where it was held for 2.5 hours. The reaction mixture was cooled to 50° C., and hydroxyethyl acrylate (61 g), phenothiazine (0.25 g), and phosphoric acid, 85% solution in water (0.3 g) were added to the reaction mixture. The reaction was continued for 3-5 hours at 110° C. till all the hydroxyethyl acrylate had reacted to yield monomer ‘D’.

### EXAMPLE 5

Maleic anhydride (477 g) was mixed with soybean oil (2150 g) and nitrogen gas was passed through the reaction mixture to remove the oxygen in the system. The reaction mixture was heated to 150° C. over 30 minutes and then heated to 215° C. where it was held for 2 hours. The reaction mixture was cooled to 90° C., and hydroxyethyl acrylate (565 g), phenothiazine (5 g), and phosphoric acid, 85% solution in water (5 g) were added to the reaction mixture. The reaction was continued for 4-5 hours at 110° C. till all the hydroxyethyl acrylate had reacted to yield monomer ‘E’, also referred to herein as SAM.

### EXAMPLE 6

Soybean oil (51.03 kg) was heated in a reactor to 100° C., and nitrogen gas was passed through the reaction mixture to remove the oxygen in the system. Maleic anhydride (11.21 kg) and xylene (2.93 mL) were added and the temperature was slowly raised to 205-210° C. and held for 2.5 hours. The maleic anhydride concentration was followed via GC. Heating was stopped when the maleic anhydride concentration reached 1-2%, and the reaction mixture was cooled to 90° C.

Phenothiazine (50 g) was mixed with hydroxyethyl acrylate (8.99 kg) and added to the reactor. Next, 81 g of phosphoric acid (85% solution in water) was added to the reaction mixture. The temperature was raised to 120° C. and heating was continued for 2.5 hours. Heating was stopped when the hydroxyethyl acrylate concentration dropped below 4% (determined by GC). The reaction mixture was cooled to 60-70° C. and the reaction product, monomer ‘F’, was discharged.

### EXAMPLE 7

Linseed oil (51.03 kg) was heated in a reactor to 100° C., and nitrogen gas was passed through the reaction mixture to remove the oxygen in the system. Maleic anhydride (11.21 kg) and xylene (2.93 mL) were added and the temperature was slowly raised to 205-210° C. and held for 2.5 hours. The maleic anhydride concentration was followed via GC. Heating was stopped when the maleic anhydride concentration reached 1-2%, and the reaction mixture was cooled to 90° C.

Phenothiazine (50 g) was mixed with hydroxyethyl acrylate (8.99 kg) and added to the reactor. Next, 81 g of phosphoric acid (85% solution in water) was added to the reaction mixture. The temperature was raised to 120° C. and heating was continued for 2.5 hours. Heating was stopped when the hydroxyethyl acrylate concentration dropped below 4% (determined by GC). The reaction mixture was cooled to 60-70° C. and the reaction product, monomer ‘G’, was discharged.

### EXAMPLE 8

Soybean oil (981 g) was heated in a reactor to 100° C., and nitrogen gas was passed through the reaction mixture to remove the oxygen in the system. Maleic anhydride (323 g) and xylene (1 drop) were added and the temperature was slowly raised to 205-210° C. and held for 4.5 hours. The maleic anhydride concentration was followed via GC. Heating was stopped when the maleic anhydride concentration reached 1-2%, and the reaction mixture was cooled to 90° C.

Phenothiazine (1.35 g) was mixed with hydroxyethyl acrylate (253 g) and added to the reactor. Next, 1.54 g of phosphoric acid (85% solution in water) was added to the reaction mixture. The temperature was raised to 120° C. and heating was continued for 3 hours. The reaction mixture was cooled to 60-70° C. and the reaction product, monomer ‘H’, was discharged.

### EXAMPLE 9

Soybean oil (981 g) was heated in a reactor to 100° C., and nitrogen gas was passed through the reaction mixture to remove the oxygen in the system. Maleic anhydride (323 g) and xylene (1 drop) were added and the temperature was slowly raised to 205-210° C. and held for 4.5 hours. The maleic anhydride concentration was followed via GC. Heating was stopped when the maleic anhydride concentration reached 1-2%, and the reaction mixture was cooled to 90° C.

Phenothiazine (1.35 g) was mixed with hydroxyethyl methacrylate (305 g) and added to the reactor. Next, 1-methyl imidazole (1.54 g) was added to the reaction mixture. The temperature was raised to 120° C. and heating was continued for 3 hours. The reaction mixture was cooled to 60-70° C. and the reaction product, monomer ‘I’, was discharged.

### EXAMPLE 10

Linseed oil (152 g) was heated in a reactor to 100° C., and nitrogen gas was passed through the reaction mixture to remove the oxygen in the system. Maleic anhydride (48 g) and xylene (1 drop) were added and the temperature was slowly raised to 205-210° C. and held for 4.5 hours. The maleic anhydride concentration was followed via GC. Heating was stopped when the maleic anhydride concentration reached 1-2%, and the reaction mixture was cooled to 90° C.

Phenothiazine (0.5 g) was mixed with hydroxyethyl methacrylate (75 g) and added to the reactor. Next, 0.5 g of phosphoric acid (85% solution in water) was added to the reaction mixture. The temperature was raised to 100° C. and heating was continued for 4-5 hours. The reaction mixture was cooled to 60-70° C. and the reaction product monomer ‘J’, was discharged.

### EXAMPLE 11

Sunflower oil (52.6 kg) was heated in a reactor to 100° C., and nitrogen gas was passed through the reaction mixture to remove the oxygen in the system. Maleic anhydride (11.57 kg) was added and the temperature was slowly raised to 205-210° C. and held for 2.5 hours. The maleic anhydride concentration was followed via GC. Heating was stopped when the maleic anhydride concentration reached 1-2%, and the reaction mixture was cooled to 90° C.

Phenothiazine (125 g) was mixed with hydroxyethyl acrylate (13.69 kg) and added to the reactor. Next, 125 g of phosphoric acid (85% solution in water) was added to the reaction mixture. The temperature was raised to 100° C. and heating was continued for 4-5 hours. The reaction mixture was cooled to 60-70° C. and the reaction product monomer ‘K’ was discharged.

### EXAMPLE 12

Maleic anhydride (48 g) was mixed with sunflower oil (152 g) and nitrogen gas was passed through the reaction mixture to remove the oxygen in the system. The reaction mixture was heated to 150° C. over 30 minutes and then heated to 200° C. where it was held for 2.5 hours. The reaction mixture was cooled to 50° C., and hydroxyethyl acrylate (58 g), phenothiazine (0.25 g), and phosphoric acid, 85% solution in water (0.25 g) were added to the reaction mixture. The reaction was continued for 3-5 hours at 80° C. till all the hydroxyethyl acrylate had reacted to yield monomer ‘L’.

### EXAMPLE 13

Maleic anhydride (49 g) was mixed with soybean oil (221 g) and nitrogen gas was passed through the reaction mixture to remove the oxygen in the system. The reaction mixture was heated to 150° C. over 30 minutes and then heated to 200° C. where it was held for 2.5 hours. The reaction mixture was cooled to 50° C., and styrene (100 g), and allyl amine (28 g) were added to the reaction mixture. The reaction was continued for 5 hours at 50° C. to yield monomer ‘M’.

### EXAMPLE 14

Maleic anhydride (49 g) and 2-methylmercaptobenzoylthiazole (0.1 g) were mixed with soybean oil (221 g) and nitrogen gas was passed through the reaction mixture to remove the oxygen in the system. The reaction mixture was heated to 150° C. over 30 minutes and then heated to 215° C. where it was held for 2.5 hours. The reaction mixture was cooled to 70° C., and phenothiazine (0.35 g), and 2-(tert-butyl amino)ethyl methacrylate (92 g) were added to the reaction mixture. The reaction was continued for 5 hours at 80° C. to yield monomer ‘N’.

### EXAMPLE 15

Maleic anhydride (49 g) and 2-methylmercaptobenzoylthiazole (0.1 g) were mixed with soybean oil (221 g) and nitrogen gas was passed through the reaction mixture to remove the oxygen in the system. The reaction mixture was heated to 150° C. over 30 minutes, and then heated to 215° C. where it was held for 2.5 hours. The reaction mixture was cooled to 90° C., and water (27 g) was added to the reaction mixture. The reaction was continued for 2.5 hours at 95° C. Then phenothiazine (0.35 g), glycidyl acrylate (128 g), and tetramethylammonium chloride (1 g) were added. The reaction was continued for 4 hours at 100° C. to yield monomer ‘O’.

### EXAMPLE 16

Maleic anhydride (49 g) and xylene (0.1 g) were mixed with soybean oil (221 g) and nitrogen gas was passed through the reaction mixture to remove the oxygen in the system. The reaction mixture was heated to 150° C. over 30 minutes and then heated to 215° C. where it was held for 2.5 hours. The reaction mixture was cooled to 90° C., and poly(ethylene glycol)monomethyl ether (140 g) and 1-methylimidazole (0.5 g) were added to the reaction mixture. The reaction was continued for 2.5 hours at 130° C. Next, phenothiazine (0.35 g), glycidyl methacrylate (56.8 g), and tetramethylammonium chloride (1 g) were added. The reaction was continued for 4 hours at 100° C. to yield monomer ‘P’.

### EXAMPLE 17

Soybean oil (981 g) was heated in a reactor to 100° C., and nitrogen gas was passed through the reaction mixture to remove the oxygen in the system. Maleic anhydride (197 g) and 2-mercaptobenzothiazole (0.363 g) were added and the temperature was slowly raised to 215-220° C. and held for 2.5 hours. The maleic anhydride concentration was followed via GC. Heating was stopped when the maleic anhydride concentration reached 1-2%, and the reaction mixture was cooled to 90° C.

Phenothiazine (1.35 g) was mixed with hydroxybutyl vinyl ether (233 g) and added to the reactor. Next, 1-methyl imidazole (1.54 g) was added to the reaction mixture. The temperature was raised to 100° C. and heating was continued for 2 hours. The reaction mixture was cooled to 60-70° C. and the reaction product, monomer ‘Q’ was discharged.

### EXAMPLE 18

Latex Synthesis

The first stage pre-emulsion was prepared by dissolving 0.005 lb (2.27 g) of Rhodapex CO 436, and 0.002 lb (0.91 g) of Igepal® CO-887 in 0.78 lb (353.38 g) of deionized water. Next, 0.072 lb (32.65 g) of butyl acrylate, 0.056 lb (25.40 g) of methyl methacrylate, and 0.0014 lb (0.64 g) of methacrylic acid was added and the mixture was stirred at high speed for 20 minutes. The initiator solution was prepared by dissolving 0.02 lb (9.07 g) of ammonium persulfate in 0.177 lb (80.29 g) of deionized water.

The second stage pre-emulsion was prepared by dissolving 0.0146 lb (6.62 g) of sodium bicarbonate, 0.092 lb (41.73 g) of Rhodapex® CO-436, and 0.034 lb (15.42 g) of Igepal CO-887 in 1.48 lb (671.32 g) of deionized water. Next, 1.34 lb (607.81 g) of butyl acrylate, 1.064 lb (482.62 g) of methyl methacrylate, 0.03 lb (13.61 g) of methacrylic acid, 0.03 lb (13.61 g) of divinyl benzene, and 0.15 lb (68.25 g) of monomer ‘F’ were added, and stirred for 5 minutes. An aqueous solution of diacetone acrylamide was prepared by dissolving diacetone acrylamide (0.117 lb, 53.07 g) in deionized water (0.132 lb, 59.87 g) and added to the pre-emulsion and stirred for 20 minutes at high agitation.

A 1-gallon reactor was charged with 0.97 lb (439.98 g) of deionized water and 0.01 lb (4.54 g) of Rhodapex CO-436. The mixture was stirred well, purged with nitrogen for 15 minutes, and heated to 80±2° C. The first stage pre-emulsion solution and 0.035 lb (15.87 g) of the initiator solution were added to the reactor. 15 minutes later, the second stage pre-emulsion, and the remaining initiator solution are fed into the reactor at constant rate over 2.75 hours and 3.0 hours, respectively.

An oxidizer solution was prepared by dissolving 0.0032 lb (1.45 g) of t-butyl hydroperoxide in 0.026 lb (11.79 g) of deionized water. A reducer solution was prepared by dissolving 0.003 lb (1.36 g) of sodium metabisulfite in 0.026 lb (11.79 g) of deionized water. The oxidizer and reducer solutions were charged to the reactor simultaneously over 1.5 hours at a constant rate. The reactor was held at the same temperature for another 30 minutes and cooled over 45 minutes to 35° C. Next, 0.57 lb (258.55 g) of ammonia was added slowly under stirring.

In another container, 0.059 lb (26.76 g) of adipic dihydrazide was dissolved in 0.06 lb (27.21 g) of deionized water, and added slowly to the latex under stirring. Lastly, the latex was filtered through a 100 mesh filter.

### EXAMPLE 19

Latex Synthesis (Continued)

Latexes with varying percentages of monomer ‘F’ were synthesized as follows. A latex without any vegetable oil monomer was synthesized and used as the control.

| | 2% | 4% | | |
|---|---|---|---|---|
| | Monomer | Monomer | 6% | |
| | ‘F’ | ‘F’ | Monomer ‘F’ | Control |
| Kettle Charge | | | | |
| Deionized water | 110.0 | 110.0 | 110.0 | 110.0 |
| Rhodapex CO-436 | 1.2 | 1.2 | 1.2 | 1.2 |
| Stage I | | | | |
| Deionized water | 166.9 | 166.9 | 166.9 | 166.9 |
| Sodium bicarbonate | 1.7 | 1.7 | 1.7 | 1.7 |
| Rhodapex CO-436 | 10.4 | 10.4 | 10.4 | 10.4 |
| Igepal CO-887 | 3.8 | 3.8 | 3.8 | 3.8 |
| Butyl acrylate | 165.0 | 160.0 | 156.0 | 169.0 |
| Methyl methacrylate | 123.0 | 121.0 | 120.0 | 125.0 |
| Divinyl benzene | 6.6 | 6.6 | 6.6 | 6.6 |
| Methacrylic acid | 3.2 | 3.2 | 3.2 | 3.2 |
| Diacetone acrylamide | 13.2 | 13.2 | 13.2 | 13.2 |
| Monomer ‘F’ | 6.2 | 12.4 | 18.8 | 0.0 |
| Initiator | | | | |
| Ammonium persulfate | 2.2 | 2.2 | 2.2 | 2.2 |
| Deionized water | 22.0 | 22.0 | 22.0 | 22.0 |
| Chaser | | | | |
| Sodium metabisulfite | 0.4 | 0.4 | 0.4 | 0.4 |
| Deionized water | 3.0 | 3.0 | 3.0 | 3.0 |
| t-Butyl hydroperoxide | 0.4 | 0.4 | 0.4 | 0.4 |
| Deionized water | 3.0 | 3.0 | 3.0 | 3.0 |
| Ammonium hydroxide | 2.1 | 2.1 | 2.1 | 2.1 |
| Adipic dihydrazide | 6.8 | 6.8 | 6.8 | 6.8 |
| Total | 650.9 | 650.1 | 651.5 | 650.7 |

### EXAMPLE 20

The latexes synthesized in examples 18 and 19 were formulated into semi-gloss coatings as per the following recipe.

| | Pounds | Gallons |
|---|---|---|
| Grind | | |
| Water | 100.00 | 12.00 |
| Natrosol ® Plus 330 | 2.00 | 0.17 |
| Potassium carbonate | 2.50 | 0.13 |
| Tamol ® 2001 | 6.25 | 0.68 |
| Drewplus ® L-475 | 2.00 | 0.26 |
| Triton ® CF-10 | 1.00 | 0.11 |
| Kathon ® LX 1.5% | 1.50 | 0.18 |
| Ti-Pure ® 706 | 230.00 | 6.90 |
| Minugel ® 400 | 5.0 | 0.25 |
| Water | 80.00 | 9.60 |
| Total | 430.25 | 30.30 |
| Letdown | | |
| Water | 138.00 | 16.57 |
| Drewplus ® L-475 | 2.00 | 0.26 |
| Strodex ® PK | 4.00 | 0.44 |
| Drewthix ® 864 | 1.00 | 0.11 |
| Drewthix 4025 | 10.00 | 1.15 |
| Latex | 469.00 | 53.30 |
| Total | 1054.25 | 102.13 |

The coatings were evaluated for various properties, and the test results are listed in the following table.

| | | 2% | 4% | 6% |
|---|---|---|---|---|
| | | Monomer | Monomer | Monomer |
| | Control | ‘F | ‘F’ | ‘F’ |
| Stormer viscosity, KU | 94.7 | 93.8 | 93.4 | 97.9 |
| ICI viscosity, Poises | 0.70 | 0.55 | 0.43 | 0.40 |
| Gloss at 20° | 20.0 | 17.3 | 17.2 | 16.6 |
| Gloss at 60° | 58.1 | 56.4 | 56.3 | 55.3 |
| 1-day block resistance | 3.5 | 3.5 | 3.5 | 4.0 |
| 7-day block resistance | 4.0 | 5.0 | 5.0 | 5.0 |
| 1 week scrub resistance | 3039 | 2267 | 2354 | 1841 |

### EXAMPLE 21

| Kettle Charge | |
|---|---|
| Deionized water | 140.00 |
| Stage I | |
| Deionized water | 165.00 |
| Rhodafac ® RS-710 | 22.40 |
| Ammonium | 2.80 |
| bicarbonate | |
| Methyl methacrylate | 98.56 |
| Butyl acrylate | 103.60 |
| Hydroxy ethyl acrylate | 14.00 |
| Silane | 28.00 |
| Monomer ‘F’ | 28.00 |
| Methacrylic acid | 8.40 |
| | 470.76 |
| Initiator | |
| Deionized water | 25.00 |
| Ammonium persulfate | 0.39 |
| t-Butyl hydroperoxide | 0.76 |
| Deionized water | 25.50 |
| Bruggolite ® FF6 | 0.65 |
| Chaser | |
| t-Butyl hydroperoxide | 0.12 |
| Deionized water | 5.00 |
| Bruggolite FF6 | 0.10 |
| Deionized water | 5.00 |
| Total | 673.29 |

### EXAMPLE 22

75.00 g of SAM monomer from Example 5 was blended with 40.61 g of sodium hydroxide solution (10 wt %) in a 1 liter jar. Sodium bicarbonate (0.50 g) was added to 350.00 g of deionized water (DI) and stirred magnetically for 1 hour. Next, 37.50 g of butyl acrylate and 37.50 g of methyl methacrylate were added into the jar and the mixture was sheared at 1800 rpm for 20 minutes to generate the preemulsion.

The preemulsion was transferred into a 1 liter glass kettle and placed in a water bath at 70° C. The initiator solution (0.90 g of ammonium persulfate in 20.00 g of DI water) was added to the preemulsion, and the reaction was continued for 2 hours. Next, the chaser solutions [oxidizer solution (0.5 g of t-butyl hydroperoxide dissolved in 15.00 g of DI water) and reducer solution (0.4 g of sodium hydrogen sulfite dissolved in 15.00 g of DI water)] were charged simultaneously into the reaction kettle over 1 hour. The latex was cooled to below 40 ° C. and discharged.

| | |
|---|---|
| Preemulsion | |
| Deionized water | 350.00 |
| Sodium bicarbonate | 0.50 |
| Butyl acrylate | 37.50 |
| Methyl methacrylate | 37.50 |
| NSAM | 75.00 |
| 10% Sodium hydroxide solution | 40.61 |
| Initiator | |
| Ammonium persulfate | 0.90 |
| Deionized water | 20.00 |
| Chaser | |
| t-butyl hydroperoxide | 0.50 |
| Deionized water | 15.00 |
| Sodium hydrogen sulfite | 0.40 |
| Deionized water | 15.00 |
| Total | |

### EXAMPLE 23

| | |
|---|---|
| Preemulsion | |
| Deionized water | 350.00 |
| Sodium bicarbonate | 0.60 |
| Butyl acrylate | 37.50 |
| Methyl methacrylate | 37.50 |
| NSAM | 75.00 |
| Ammonium hydroxide (29%) | 5.95 |
| Deionized water | 38.66 |
| Initiator | |
| Ammonium persulfate | 0.90 |
| Deionized water | 20.00 |
| Chaser | |
| t-butyl hydroperoxide | 0.50 |
| Deionized water | 15.00 |
| Sodium hydrogen sulfite | 0.40 |
| Deionized water | 15.00 |
| Total | |

### EXAMPLE 24

Preparation of Textile Finish Water Baths

Maleic anhydride (477 g) was mixed with soybean oil (2150 g) and nitrogen gas was passed through the reaction mixture to remove the oxygen in the system. The reaction mixture was heated to 150° C. over 30 minutes and then heated to 215° C. where it was held for 2 hours. The reaction mixture was cooled to 90° C., and phenothiazine (5 g), and phosphoric acid, 85% solution in water (5 g) were added to the reaction mixture and allowed to cool toambient temperature to yield monomer MSO-2.

29% Ammonium hydroxide (50.72 g) was added to MSO-2 (50.35 g) under moderate stirring to prepare neutralized MSO-2 (NMSO-2). 15.0 g of NMSO-2 was blended with 485.0 g of deionized water to prepare a bath containing 3% of NMSO-2. Similar baths were prepared to contain 8% and 13% of NMSO-2. A control bath was prepared by dissolving 40.0 g of 29% ammonium hydroxide in 460.0 g of deionized water.

Soy acrylate macromonomer (SAM) from Example 5 was neutralized with 29% ammonium hydroxide to prepare neutralized SAM (NSAM) (pH 8.5). 40.0 g of NSAM was blended with 460.0 g of deionized water to prepare a bath containing 8% NSAM. A textile finish bath was also prepared containing 15% NSAM.

40.0 g of NSAM-based latex (from Examples 22 and 23) was blended with 460.0 g of deionized water to prepare a bath containing 8% NSAM-based latex.

Fabric Treatment

Sheets measuring 1 ft×2 ft of test fabric (Style #400 obtained from Testfabrics, Inc., PA) were soaked in textile finish water baths for 2 minutes. The fabric was removed from the bath and excess finish was removed using a clothes wringer (Model BL-38 from Dyna-Jet Products, KS). The sheets were then hung slack in a drying oven at 150° C. for 10 minutes.

Mechanical Properties Evaluation

The treated fabric samples were conditioned for a minimum of 6 hours at 65±3% relative humidity and 20±2° C., and tested for resiliency (Wrinkle Recovery Angle Measurement AATCC Test Method 66-1998) and tear resistance (ASTM D 1424-96). Tear resistance was measured with a 1600 lb-force pendulum capacity. The tensile testing of 1″×8″ fabric specimens was performed according to ASTM D 5035-95. The breaking stress was determined with a 300 mm/min extension rate with a 1000 lb load cell. The mechanical performance was measured in the fabric processing directions of warp (the direction in which the fabric is removed from the weaving loom) and weft (the direction transverse to the weaving loom). Tables I, II, and III show that treated fabrics had better resiliency without compromising tear strength.

TABLE I
Mechanical Properties of NMSO-2 Treated Fabrics

| | Untreated | | | | | | | | | |
|---|---|---|---|---|---|---|---|---|---|---|
| | Cotton | | NMSO | | NMSO | | Control | | NMSO | |
| | OWB | | | | | | | | | |
| | 0% | | 3% | | 8% | | 8% | | 13% | |
| Fabric direction | Warp | Weft | Warp | Weft | Warp | Weft | Warp | Weft | Warp | Weft |
| Tear (lb-f) | 1136 | 784 | 1136 | 768 | 1184 | 768 | 1076 | 864 | 1152 | 768 |
| Tear (% SR) | 100 | 100 | 100 | 98 | 104 | 98 | 95 | 110 | 101 | 98 |
| Tensile (lb) | 44 | 29 | 37 | 15 | 41 | 16 | 40 | 25 | 35 | 22 |
| Tensile (% SR) | 100 | 100 | 86 | 52 | 94 | 57 | 91 | 88 | 80 | 76 |
| WRA (°) | 66 | 52 | 100 | 94 | 97 | 114 | 79 | 86 | 78 | 87 |

| | | | | | |
|---|---|---|---|---|---|
| WRA: W + F (°) | 119 | 194 | 212 | 165 | 166 |

SR: Strength Retention (treated fabric strength divided by the strength of untreated fabric)
OWB: On Weight of the Bath (mass of auxillary divided by the mass of the total finish bath)

TABLE II
Mechanical Properties of NSAM Treated Fabrics

| | Untreated | | | | | |
|---|---|---|---|---|---|---|
| | Cotton | | NSAM | | NSAM | |
| | OWB | | | | | |
| | 0% | | 8% | | 15% | |
| Fabric direction | Warp | Weft | Warp | Weft | Warp | Weft |
| Tear (lb · f) | 1136 | 784 | 1104 | 773 | 1152 | 704 |
| Tear (% SR) | 100 | 100 | 97 | 99 | 101 | 90 |
| Tensile (lb) | 44 | 29 | 41 | 20 | 32 | 22 |
| Tensile (% SR) | 100 | 100 | 94 | 70 | 74 | 75 |
| WRA (°) | 66 | 52 | 83 | 76 | 91 | 104 |

| | | | |
|---|---|---|---|
| WRA: W + F (°) | 119 | 159 | 195 |

TABLE III
Mechanical Properties of NSAM-Based Latex Treated Fabrics

| | Untreated | | | | | |
|---|---|---|---|---|---|---|
| | Cotton | | Example 1 | | Example 2 | |
| | OWB | | | | | |
| | 0% | | 8% | | 8% | |
| Fabric direction | Warp | Weft | Warp | Weft | Warp | Weft |
| Tear (lb · f) | 1136 | 768 | 1184 | 720 | 1216 | 768 |
| Tear (% SR) | 100 | 100 | 104 | 91 | 108 | 99 |
| Tensile (lb) | 44 | 29 | 38 | 25 | 33 | 27 |
| Tensile (% SR) | 100 | 100 | 86 | 88 | 75 | 94 |
| WRA (°) | 66 | 52 | 83 | 81 | 78 | 81 |

| | | | |
|---|---|---|---|
| WRA: W + F (°) | 119 | 164 | 158 |

### EXAMPLE 25

Mechanical Durability of NMSO Treated Fabric upon Laundering

Treated fabrics were laundered in a 20 lb Speed Queen® washer-extractor (by Alliance Laundry Systems LLC, WI) for 5 and 10 cycles of washing and air drying on a perforated screen. Washes consisted of treated fabric sheets combined with 50/50 polyester/cotton ballast fabric for a total mass of 1000 g of fabric. Each wash utilized 38 grams of AATCC Standard Reference Detergent on ‘normal’ at 47° C. and rinses at 23° C. The mechanical performance of untreated cotton and treated cotton after 0, 5, and 10 wash cycles are listed in Table II. As seen in Table II, the resiliency and strength of untreated cotton fabric decreases with increased laundering cycles. After 10 washes, the mechanical performance of NMSO treated fabrics was superior to untreated cotton fabric.

TABLE IV
Laundering Durability of 8% OWB NMSO

| | | |
|---|---|---|
| | Untreated | 8% OWB |
| Wash | Cotton | NMSO |

| | Cycles | Warp | Weft | Warp | Weft |
|---|---|---|---|---|---|
| Tensile (lb) | 0 | 76 | 79 | 40 | 28 |
| | 5 | 51 | 38 | 41 | 26 |
| | 10 | 35 | 46 | 43 | 29 |
| Tear (lb) | 0 | 1006 | 635 | 829 | 485 |
| | 5 | 1024 | — | 679 | 447 |
| | 10 | 880 | 560 | 683 | 406 |
| WRA (°) | 0 | 74 | 73 | 112 | 111 |
| | 5 | 51 | 38 | 119 | 109 |
| | 10 | 35 | 46 | 103 | 94 |

What is claimed is:

1. A textile finish composition comprising the reaction product of;
an unsaturated vegetable oil that has been modified by the addition of an enophile or dienophile having an acid, ester or anhydride functionality and base netralized; and
a functional vinyl monomer.

2. The composition of claim 1 wherein the vegetable oil is selected from the group consisting of soybean oil, linseed oil and sunflower oil.

3. The composition of claim 1 wherein the vegetable oil comprises soybean oil.

4. The composition of claim 1 wherein the vegetable oil comprises linseed oil.

5. The composition of claim 1 wherein the vegetable oil comprises sunflower oil.

6. The composition of claim 1 wherein the enophile or dienophile is selected from the group consisting of maleic anhydride, fumaric acid, itaconic anhydride and maleate esters.

7. The composition of claim 1 wherein the functional vinyl monomer is selected from the group consisting of hydroxy, amine, thiol and oxirane vinyl monomers.

8. The composition of claim 1 wherein the vinyl monomer is selected from the group consisting of hydroxyethyl acrylate, hydroxyethyl methacrylate, allyl amine, 2-(tert-butylamino)ethyl methacrylate, glycidyl acrylate, glycidyl methacrylate, and hydroxybutyl vinyl ether.

9. A latex polymer comprising the polymerization product of:
an ethylenically unsaturated monomer suitable for forming a latex polymer; and the reaction product of an unsaturated vegetable oil that has been modified by the addition of an enophile or dienophile having an acid, ester or anhydride functionality and based neutralized, and a functional vinyl monomer.

10. The latex of claim 9 wherein the vegetable oil is selected from the group consisting of soybean oil, linseed oil and sunflower oil.

11. The latex of claim 9 wherein the functional vinyl monomer is selected from the group consisting of hydroxy, amine, thiol and oxirane vinyl monomers.

12. The latex of claim 9 wherein the vinyl monomer is selected from the group consisting of hydroxy ethyl acrylate, hydroxy ethyl methacrylate, allyl amine, 2-(tert-butylamino)ethyl methacrylate, glycidyl acrylate, glycidyl methacrylate, and hydroxybutyl vinyl ether.

13. The latex of claim 9 wherein the ethylenically unsaturated monomer is selected from the group consisting of vinyl acetate, vinyl chloride, vinyl ester of a saturated tertiary branched carboxylic acid, acrylonitrile, acrylamide, diacetone acrylamide, 2-ethylhexyl acrylate, 2-ethylhexyl methacrylate, 2-hydroxyethyl acrylate, 2-hydroxyethyl methacrylate, glycidyl acrylate, glycidyl methacrylate, acrylic acid, methacrylic acid, butyl acrylate, butyl methacrylate, methyl methacrylate, methyl acrylate, para-acetoxystyrene, and styrene.
